(19) United States
(12) Patent Application Publication
(10) Pub. No.: US 2015/0145591 A1
(43) Pub. Date: May 28, 2015

(54) CHARGE PUMP WITH REDUCED CURRENT CONSUMPTION

(71) Applicant: Atmel Corporation, San Jose, CA (US)

(72) Inventors: Martin Fischer, Heilbronn (DE); Volkhard Flassnoecker, Heilbronn (DE)

(21) Appl. No.: 14/087,850

(22) Filed: Nov. 22, 2013

(51) Int. Cl. H02M 3/07; H02M 1/08

(52) U.S. Cl. CPC H02M 3/07; H02M 1/08
USPC 327/536

(57) ABSTRACT

The output voltage of a LP HV charge pump is compared with a voltage reference using a comparator having hysteresis. When the output voltage exceeds the reference voltage, an input clock to the charge pump is turned off, causing the output voltage to fall due to leakage current in the non-volatile memory. After a time delay due to the hysteresis of the comparator, the input clock is turned on, causing the output voltage to rise again until the voltage reference is again exceeded at which time the input clock is again turned off again. The process repeats, resulting in a reduction of average current consumption by the LP HV charge pump.

### TECHNICAL FIELD

This disclosure relates generally to regulating output voltage of a charge pump.

### BACKGROUND

In automotive transponder systems, a key is inserted into an ignition lock of an automobile and turned to an ‘on’ or ‘run’ position. An induction coil that is mounted around the ignition lock sends out a continuous low frequency (LF) electromagnetic field of energy (e.g., 125 kHz). Windings in the transponder chip absorb that energy and power the electronic chip in the key to emit a signal, such as an identification code. The induction coil reads the signal and sends it to a computer or “reader” in the automobile to recognize the signal. If the signal is recognized as being already in the computer's memory the signal is accepted and other electronic components in the vehicle are engaged to allow starting of the vehicle or continuation of the automobile engine running

Some transponder systems include non-volatile memory that can be programmed (e.g., EEPROM). Erasing cells of non-volatile memory requires a voltage that is higher than the power source (e.g., a battery) can provide. To generate the higher voltage, transponders may include a charge pump. The charge pump uses capacitors as energy storage elements to create the higher voltage. Most charge pumps use some form of switching device to control the connection of voltages to the capacitors. An external or secondary circuit (e.g., a clock) drives the switching, typically at tens of kilohertz up to several megahertz. The high frequency clock minimizes the amount of capacitance required as less charge needs to be stored and dumped in a shorter cycle.

If the transponder does not have a power source (e.g., no battery) or an insufficient power source (e.g., low battery), then the transponder must get its energy from the LF electromagnetic field provided by the reader as described above. The transponder gets the energy out of the LF field and stores the energy in a large capacitor (e.g., an external capacitor). If the user wants to write data to non-volatile memory and the charge pump takes too much energy out of the capacitor the writing of the data to memory will fail. The user will then have to move the transponder closer to the field source (e.g., closer to the reader) to get more energy to the capacitor and write the data again.

### SUMMARY

The output voltage of a LP HV charge pump is compared with a voltage reference using a comparator having hysteresis. When the output voltage exceeds the reference voltage, an input clock to the charge pump is turned off, causing the output voltage to fall due to leakage current in the non-volatile memory. After a time delay due to the hysteresis of the comparator, the input clock is turned on, causing the output voltage to rise again until the voltage reference is again exceeded at which time the input clock is again turned off again. The process repeats, resulting in a reduction of average current consumption by the LP HV charge pump.

In some implementations, a portion of the output voltage is compared with the reference voltage. The output voltage can be divided using a capacitive voltage divider that consumes less current than, for example, a resistive voltage divider. In some implementations, the capacitive voltage divider is programmable to provide an optimal setting for the portion of output voltage supplied as input to the comparator. In some implementations, the reference voltage is supplied by a temperature stable and trimmed band gap voltage.

In some implementations, a circuit including a charge pump with reduced current consumption comprises: a charge pump; a voltage divider coupled to an output of the charge pump; and a comparator with hysteresis having a first input coupled to an output of the voltage divider, a second input coupled to a reference voltage and an output coupled to the charge pump. The output is operable for turning the charge pump off when a first threshold voltage is reached and for turning the charge pump on when a second threshold voltage is reached and after a time delay caused by the internal hysteresis of the comparator.

In some implementations, a method for reducing current consumption in a circuit including a charge pump, comprises: turning on a charge pump; determining, using a comparator with hysteresis, that the charge pump output voltage has reached a first threshold voltage; turning off the charge pump; determining that the output voltage has reached a second threshold voltage; and turning on the charge pump after a delay caused by the hysteresis.

Particular implementations of the LP HV charge pump with reduced current consumption provide one or more of the following advantages. The amount of current consumed by a charge pump to generate sufficiently high voltage for writing to non-volatile memory is reduced. Reducing the current consumption increases the writing range of LF wireless transponders.

### BRIEF DESCRIPTION OF THE DRAWINGS

FIG. 1 is a plot illustrating the transient behavior of an LP HV charge pump.

FIG. 2 is a block diagram of an example LP HV charge pump and control loop system.

FIG. 3 is a block diagram illustrating the programming of capacitor values for the capacitor voltage divider of FIG. 2.

FIG. 4 is a flow diagram of a process of controlling current consumption of a LP HV charge pump.

### DETAILED DESCRIPTION

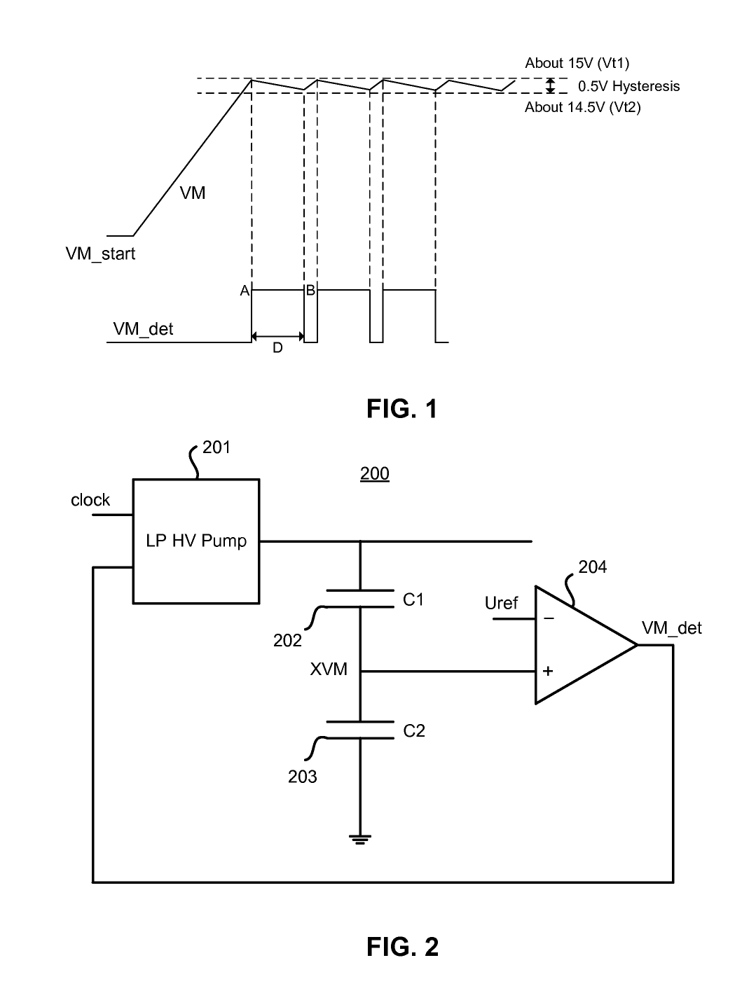

FIG. 1 is a plot illustrating the transient behavior of an LP HV charge pump. When the LV HP charge pump is started (e.g., by starting an input clock), the output voltage of the LV HP charge pump, VM, pumps up from the supply voltage (e.g., 1.9-4.2V) to the desired output voltage or first threshold voltage Vt1 (e.g., 15V). In some implementations, the supply voltage can be a battery or a capacitor that has been charged by an electromagnetic energy field (e.g., transponder application).

When VM exceeds Vt1 (e.g., VM>Vt1) at point A, the comparator triggers and turns off the input clock to the LP HV charge pump. The leakage current of the load (e.g., EEPROM) discharges VM from Vt1 to a second threshold voltage Vt2 (e.g., from 15V to 14.5V) at point B (VM<Vt2), causing the comparator to reset and turn the LP HV charge pump back on. The time delay D between point A and point B is due to the hysteresis of the comparator and can be programmed as desired. This pattern of charging and discharging repeats, such that the average current consumed by the charge pump is reduced without jeopardizing the capability of the LP HV charge pump to deliver the desired output voltage VM to the load when needed.

### Example Circuit

FIG. 2 is a block diagram of an example LP HV charge pump and control loop system 200. In some implementations, system 200 includes LP HV charge pump 201, capacitors 202, 203 and comparator 204. System 200 can be included in an IC chip. The example circuit configuration could include additional circuitry not shown. For example, a clamping circuit (e.g., Zener diode) can be coupled to VM for overvoltage protection.

LP HV charge pump 201 has a clock input coupled to the output, VM_det of comparator 204 and is turned on and off by VM_det based on the output of comparator 204. Comparator 204 has a first input coupled to voltage XVM, which generated by a capacitor voltage divider that includes capacitors 202, 203. Comparator 204 has a second input that is coupled to reference voltage Uref. In some implementations, Uref is provided by a temperature stable and trimmed bandgap voltage. An example value for capacitor 202 (C1) is 300 fF and an example value for capacitor 203 (C2) is 3.5 pF.

In operation, comparator 204 continuously compares XVM with Uref and triggers when XVM exceeds Uref, turning off LP HV charge pump 201 by, for example, turning off its input clock. Comparator 204 resets when XVM is below Uref after a delay D due to the hysteresis of comparator 204, causing LP HV charge pump 201 is turned on again by, for example, turning on its input clock.

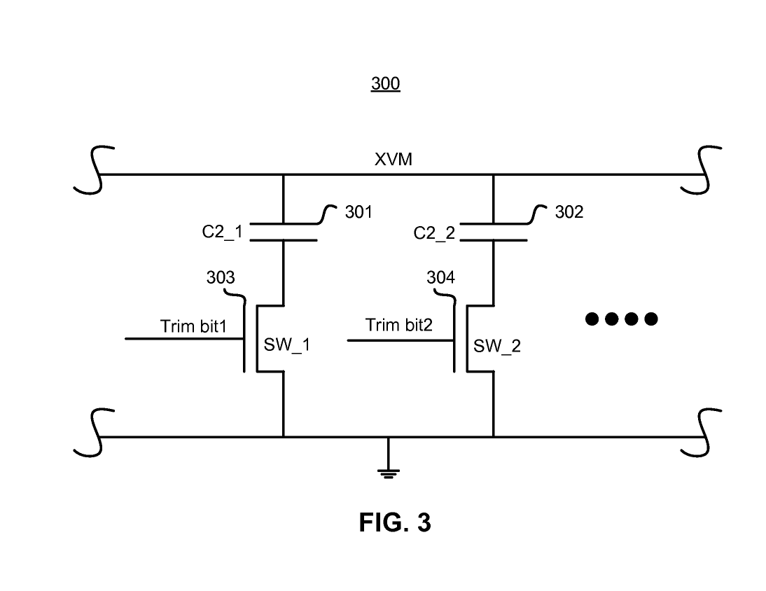

FIG. 3 is a block diagram illustrating the programming of capacitor values for the capacitor voltage divider of FIG. 2. The capacitive voltage divider that includes capacitors 202, 203 can be made programmable to find an optimal setting for VM. In some implementations, circuit 300 includes N capacitors coupled in parallel. In the example shown, capacitors 301, 302 are coupled in parallel by switches 303 (SW_1), 304 (SW_2) based on the values of trim bits. Capacitor 203 (C2) can be replaced with capacitors 303, 304 (C2_1, C2_2), where N is a positive integer that indicates the number of capacitors coupled in parallel. Switches 303, 304 can be implemented by transistors (e.g., MOSFET transistors) configured (e.g., biased) to behave like switches. Trim bits can be hardwired or programmed into a hardware register or stored in memory.

### Example Processes

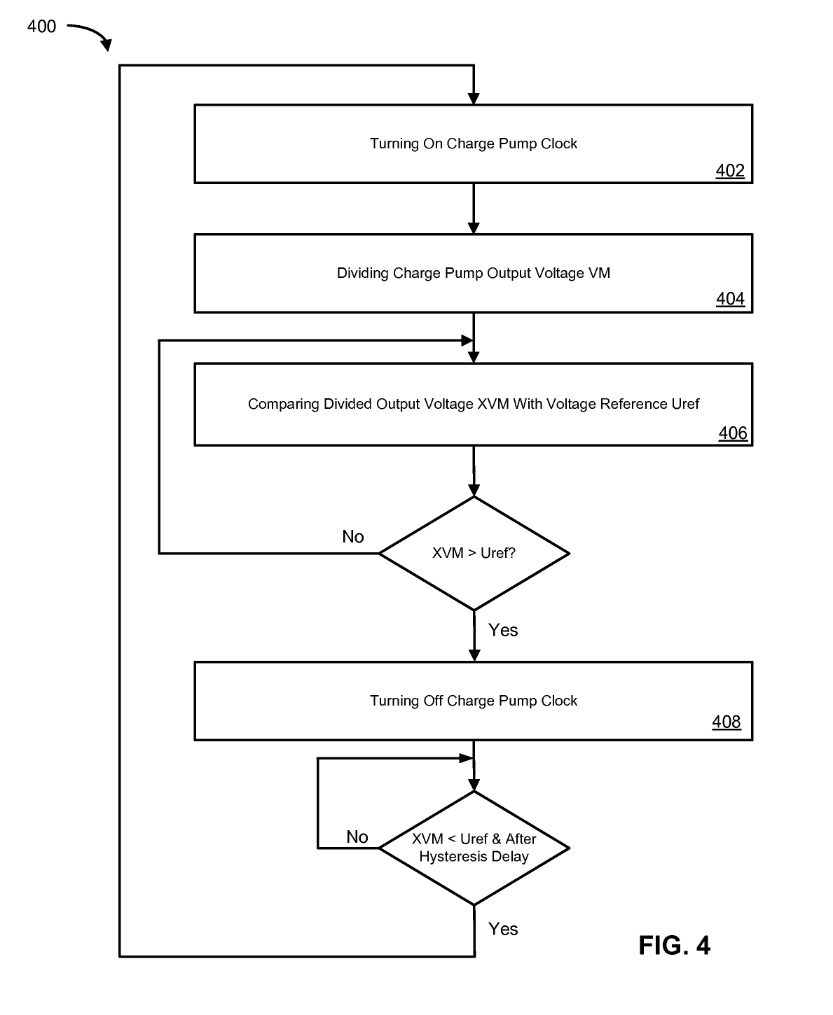

FIG. 4 is a flow diagram of process 400 of controlling current consumption of a LP HV charge pump. Process 400 can be implemented by system 200 described in reference to FIGS. 2 and 3.

In some implementations, process 400 can begin by turning on a charge pump input clock to start pumping up the output voltage VM from a supply voltage to a desired first threshold voltage (402). Process 400 can continue by dividing VM to provide a portion of VM (XVM) to a comparator (404). In some implementations VM is divided into XVM using a capacitive voltage divider. The capacitive voltage divider can be made programmable by, for example, using trim bits and switches to couple a number of capacitors in parallel, as described in reference to FIG. 3.

Process 400 can continue by comparing the divided output voltage XVM to a reference voltage Uref (406). In some implementations, Uref is provided by a temperature stable and trimmed bandgap voltage. The reference voltage Uref can be generated internal to an IC or external to an IC that includes the LP HV charge pump.

If XVM is greater than the first threshold voltage (Vt1), the LP HV charge pump is turned off (408). For example, when XVM>Vt1 the comparator output triggers (e.g., goes high) and that output is used to disconnect the input clock to the LP HV charge pump using, for example, a switch coupled to the clock input (not shown). Process 400 continues by turning on the LP HV charge pump (402) when XVM drops below a second threshold voltage (Vt2) and after a delay due to hysteresis of the comparator. For example, when XVM<Vt2 the comparator output resets after a hysteresis delay D, as shown in FIG. 1.

The system and method described above provide several advantages over conventional voltage regulation schemes. For example, the control loop described above provide that the LP HV pump will only draw current when it is needed and the smooth rise of VM during charging is good for data retention (not too high voltage) in non-volatile memory applications. For ICs having leakage current <200 nA a significant amount of supply current (e.g., 10 uA) can be saved. The leakage current of the load (e.g., EEPROM) can be measured, the capacitor at VM, the hysteresis voltage and hysteresis delay (off-time) can all be easily measured. If a Zener clamp or other overvoltage protection circuit is used to clamp VM (e.g., clamp to 16.5 V), the overprotection circuit will not draw additional current, which is the case when the control loop shown in FIG. 2 is not used.

While this document contains many specific implementation details, these should not be construed as limitations on the scope what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can, in some cases, be excised from the combination, and the claimed combination may be directed to a sub combination or variation of a sub combination.

What is claimed is:

1. A circuit comprising:
a charge pump;
a voltage divider coupled to an output of the charge pump; and
a comparator with hysteresis having a first input coupled to an output of the voltage divider, a second input coupled to a reference voltage and an output coupled to the charge pump, where the output is operable for turning the charge pump off when a first threshold voltage is reached and for turning the charge pump on when a second threshold voltage is reached and after a time delay caused by the hysteresis of the comparator.

2. The circuit of claim 1, where the charge pump is a low power (LP), high voltage (HV) charge pump.

3. The circuit of claim 1, where the voltage divider is a capacitive voltage divider.

4. The circuit of claim 3, where the capacitive voltage divider is programmable.

5. The circuit of claim 4, where the capacitor voltage divider is programmed by adding to or removing from the capacitive voltage divider one or more capacitors.

6. The circuit of claim 1, where the reference voltage is a temperature stable voltage.

7. The circuit of claim 1, where the charge pump is turned-on or turned-off by the output of the comparator by turning on or turning off a clock of the charge pump.

8. The circuit of claim 1, where the circuit is included in an integrated circuit (IC) chip.

9. The circuit of claim 1, where the IC is included in a transponder that also includes non-volatile memory coupled to the output voltage of the charge pump.

10. The circuit of claim 1, where the hysteresis of the comparator is internal and adjustable by external circuitry.

11. The circuit of claim 1, where the hysteresis of the comparator is external to the comparator and provided by a network of passive components.

12. The circuit of claim 1, further comprising non-volatile memory coupled to the charge pump output voltage.

13. A method comprising:
turning on a charge pump;
determining, using a comparator with hysteresis, that the charge pump output voltage has reached a first threshold voltage;
turning off the charge pump;
determining that the output voltage has reached a second threshold voltage; and
turning on the charge pump after a delay caused by the hysteresis.

14. The method of claim 13, where the charge pump is a low power (LP), high voltage (HV) charge pump.

15. The method of claim 13, further comprising:
dividing the output voltage by a voltage divider;
comparing, using the comparator, a portion of the output voltage with the first threshold voltage; and
turning the charge pump off based on a result of the comparing.

16. The circuit of claim 15, where the voltage divider is a capacitive voltage divider.

17. The circuit of claim 16, where the capacitive voltage divider is programmable.

18. The circuit of claim 17, where the capacitor voltage divider is programmed by adding to or removing from the capacitive voltage divider one or more capacitors.

19. The circuit of claim 13, where the first threshold voltage is set by a temperature stable reference voltage.

20. The circuit of claim 13, where turning-on or turning-off the charge pump includes turning-on or turning-off a clock input to the charge pump.
